(19) United States
(12) Patent Application Publication
(10) Pub. No.: US 2018/0132448 A1
(43) Pub. Date: May 17, 2018

(54) EDIBLE PET BOWL AND METHOD

(71) Applicants: Claudia P. Rodriguez, Boerne, TX (US); Michael A. Rodriguez, Boerne, TX (US)

(72) Inventors: Claudia P. Rodriguez, Boerne, TX (US); Michael A. Rodriguez, Boerne, TX (US)

(21) Appl. No.: 15/814,725

(22) Filed: Nov. 16, 2017

Related U.S. Application Data
(60) Provisional application No. 62/423,074, filed on Nov. 16, 2016.

(51) Int. Cl. A01K 5/01; A01K 7/00; A01K 15/02

(52) U.S. Cl. CPC A01K 5/0114; A01K 15/026; A01K 7/00

(57) ABSTRACT

A pet bowl includes a container having a circular base and an annular sidewall including and outer wall, an inner wall, and an upper rim. The container is constructed from a consumable rawhide. Both the upper rim and the circular base have specified diameters. The annular sidewall and the circular base are integrated together as a single unit. The annular sidewall forms a concave depression for containing food or water, with the bottom of the depression being formed by the circular base. The inner and outer walls of the sidewall are concentric to each other, and terminate at their upmost in a rim.

### CROSS-REFERENCE TO RELATED APPLICATION(S)

The present application is related to and claims priority to U.S. Provisional Patent Application No. 62/423,074 filed Nov. 16, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of feeding bowls of existing art and more specifically relates to edible pet bowls.

### RELATED ART

Many domesticated pets, and particularly canines, are prone to chewing. Chewing is a natural instinct for many prey animals that is necessary to maintain good dental health. Regular chewing may help an animal strengthen the teeth and gum(s), and also is effective in removing tartar buildup on teeth. Chewing exercises may also help strengthen an animal's jaw and neck.

As a result, many pets chew with such zeal that they destroy objects in a household, such as furniture, bedding, and other items which is undesirable. Toys may be provided to displace these items from being destroyed, but this can be inconvenient and expensive, littering a household with chew toys. A suitable solution is desired.

U.S. Pat. No. 6,918,809 to Stanley Edwin Persall relates to a multipurpose disc toy. The described multipurpose disc toy includes a multipurpose disc useful as a throw, tug, and chew toy for play involving pets and for play involving pets and people, and useful as a water and food dish for pets. The disc comprises a circular top portion, an annular sidewall portion that merges with the circular top portion, an annular flange portion that merges with the annular sidewall portion, the annular flange and circular top portions being disposed in parallel spaced planes, a convex outer side, and, a concave inner side.

### SUMMARY OF THE INVENTION

In view of the foregoing disadvantages inherent in the known feeding bowl art, the present disclosure provides a novel edible pet bowl and method. The general purpose of the present disclosure, which will be described subsequently in greater detail, is to provide an efficient, effective and novel edible pet bowl and method.

A pet bowl is disclosed herein. The pet bowl includes a container having a substantially circular base and an annular sidewall including and outer wall, an inner wall, and an upper rim. The container is preferably constructed from a consumable rawhide. Both the upper rim and the circular base have specified preferred diameters. The annular sidewall and the circular base are integrated together as a single unit. The annular sidewall forms a concave depression for containing food or water, with the bottom of the depression being formed by the circular base. The inner and outer walls of the sidewall are concentric to each other, and terminate at their upmost in a rim.

According to another embodiment, a method of using the pet bowl is also disclosed herein. The method of using the pet bowl includes firstly, providing the pet bowl as described; secondly, filling the container with a fluid and alternately a comestible; thirdly, allowing a pet to feed from the container; fourthly, allowing the pet to chew the container; and fifthly, allowing the pet to consume the container.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an edible pet bowl and method, constructed and operative according to the teachings of the present disclosure.

FIG. 1 is a perspective view of the pet bowl during an ‘in-use’ condition, according to an embodiment of the disclosure.

FIG. 2A is a perspective view of the pet bowl of FIG. 1, according to an embodiment of the present disclosure.

FIG. 2B is a perspective view of the pet bowl of FIG. 1, according to an embodiment of the present disclosure.

FIG. 3A is a perspective view of the pet bowl of FIG. 1, according to an embodiment of the present disclosure.

FIG. 3B is a perspective view of the pet bowl of FIG. 1, according to an embodiment of the present disclosure.

FIG. 4A is a bottom perspective view of the pet bowl of FIG. 1, according to an embodiment of the present disclosure.

FIG. 4B is a bottom perspective view of the pet bowl of FIG. 1, according to an embodiment of the present disclosure.

FIG. 5 is a flow diagram illustrating a method of using an edible pet bowl, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a feeding bowl and more particularly to an edible pet bowl and method as used to improve the use of pet bowls for edible use.

Generally, the edible pet bowl is a feeding dish designed to provide the functions of both a food container or water dish as well as a chew toy. The edible pet bowl is composed of a rawhide, such a beef or pork rawhide, such that the entire container may be chewed and consumed by a pet, particularly a canine. The edible pet bowl may be used to replace traditional chew toys, helping prevent a pet from chewing and damaging household objects that should not be chewed. The pet bowl may be used to serve food or water like a traditional dish, and then may be subsequently used by the pet as a chewing device. The edible pet bowl may be suitable to occupy the pet for hours. As the edible pet bowl is chewed on and becomes saturated with saliva, it will become easier for the pet to deform the bowl and eventually break the bowl up into smaller pieces for consumption.

The edible pet bowl resembles a traditional food dish, yet with novel difference, having a base and a sidewall defining a cavity terminating upwardly in a circular rim. Some embodiments of the edible pet bowl may incorporate a cylindrical sidewall, while other embodiments may have a taper such that the diameter of the upper rim is either larger or smaller than the diameter of the base. Many shapes and sizes are envisioned. The sidewall may be solid or may include a hollow interior. A preferred embodiment includes the design of dog bones embossed into the exterior of the bowl. Various sizes, colors, and ornamental designs may be implemented into the edible pet bowl with functional utility.

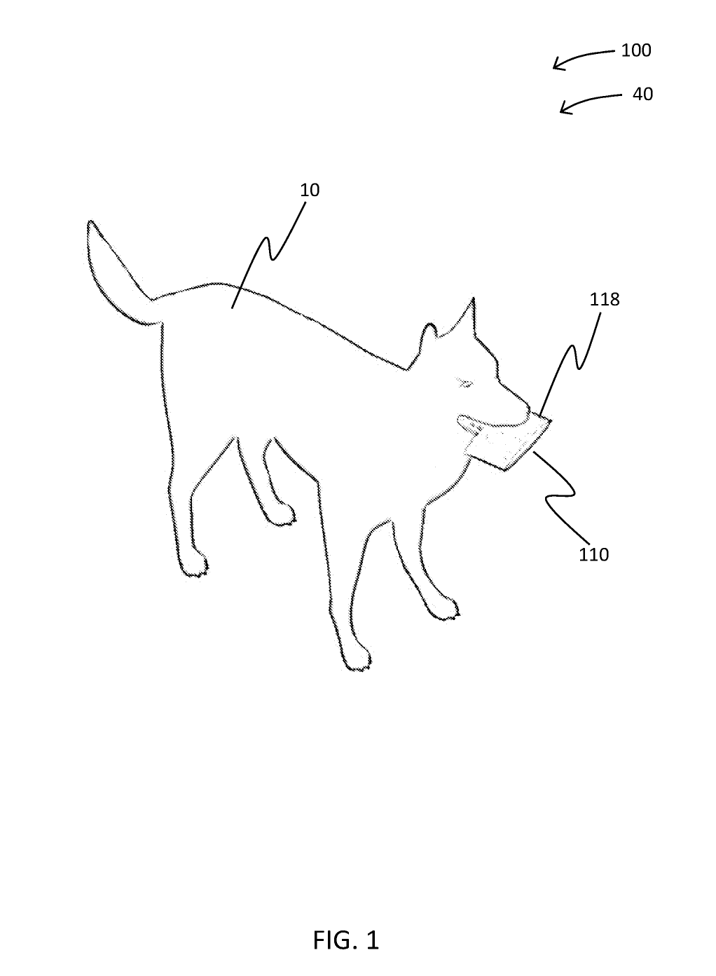

Referring now more specifically to the drawings by numerals of reference, there is shown in FIGS. 1-4B, various views of a pet bowl 100.

FIG. 1 shows a pet bowl 100 during an ‘in-use’ condition 50, according to an embodiment of the present disclosure. Here, the pet bowl 100 may be beneficial for use by a user 40 to provide a pet with a consumable and chewable feeding bowl. As illustrated, the pet bowl 100 may include a container 110 comprising rawhide 118. Rawhide 118 comprises beef hide and alternately pork hide in preferred embodiments. Rawhide 118 also comprises granulated rawhide and alternately compressed rawhide. Rawhide 118 is chewable, such that rawhide 118 also functions as a tooth strengthening mechanism. Rawhide 118 becomes flexible and deformable when saturated with saliva, container 110 being configured to deform when chewed by animal 10. Upon reading this specification, it should be appreciated that, under appropriate circumstances, considering such issues as user preferences, design preference, structural requirements, marketing preferences, cost, available materials, technological advances, etc., other structural arrangements such as, for example, multiple bowl concavities, alternative base structures, etc., may be sufficient.

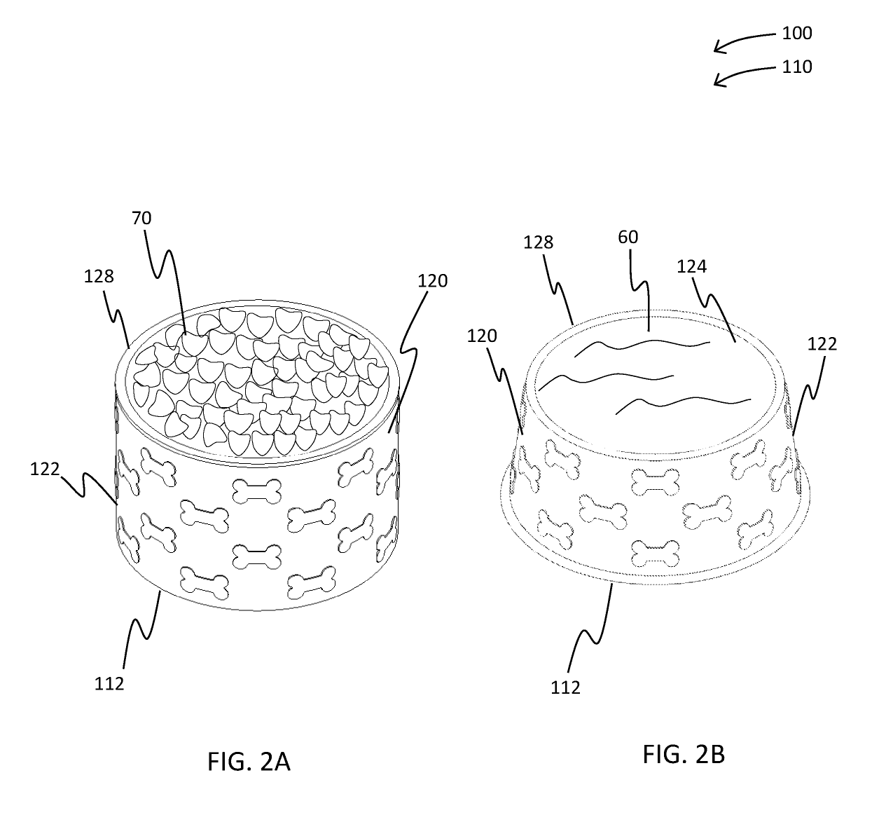

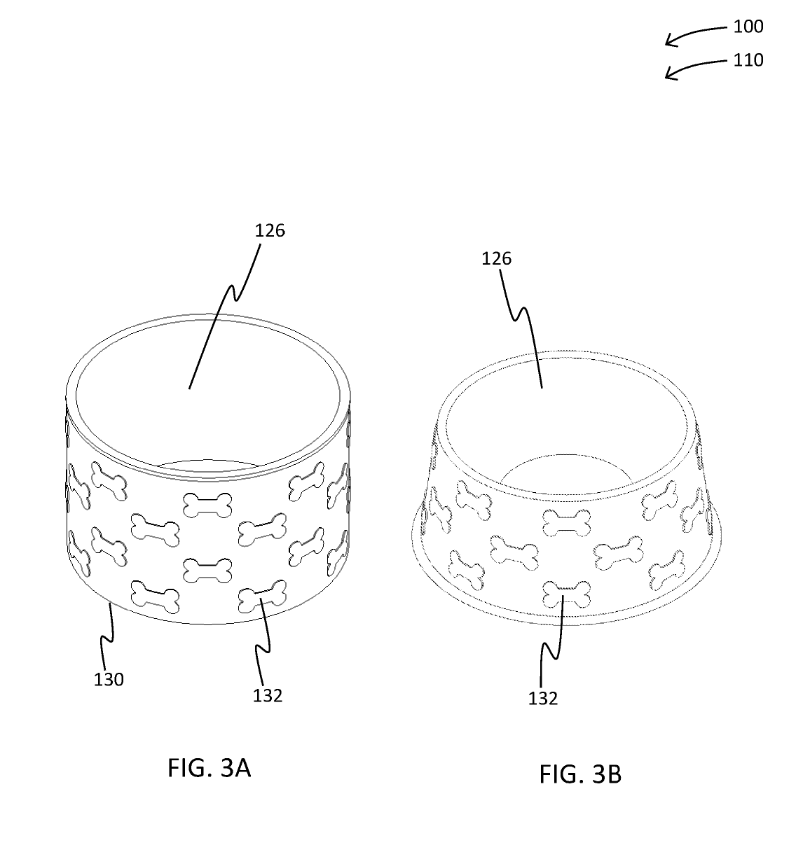

Referring now to FIG. 2A and FIG. 2B showing the pet bowl 100 of FIG. 1, according to an embodiment of the present disclosure. As above, the pet bowl 100 may include a container having a circular base and an annular sidewall. Container 110 is preferably constructed of rawhide 118. Container 110 includes a substantially circular base 112 having a base-diameter 114 and annular sidewall 120. Annular sidewall 120 is integrated with substantially circular base 112 defining upwardly-facing inner concavity 126 (FIG. 3) configured to contain fluid 60 and alternatively comestible 70; annular sidewall 120 having outer wall 122, inner wall 124 concentric to outer wall 122, and upper rim 128 terminating outer wall 122 and inner wall 124, having rim-diameter 116.

FIGS. 3A and 3B are perspective views of the pet bowl 100 of FIG. 1, according to an embodiment of the present disclosure. Container 110 further includes chamfer 130 joining annular sidewall 120 of container 110 to substantially circular base 112 (FIG. 2) of container 110. Container 110 further includes ornamental embellishments 132 molded into the side of outer wall 122 (FIG. 2) of annular sidewall 120 (FIG. 2) of container 110 for providing identification and personalization to pet bowl 100. Ornamental embellishments 132 resemble bones for providing further identification and personalization to the pet bowl such that animals can be readily identified with their respective pet bowl 100 and the like.

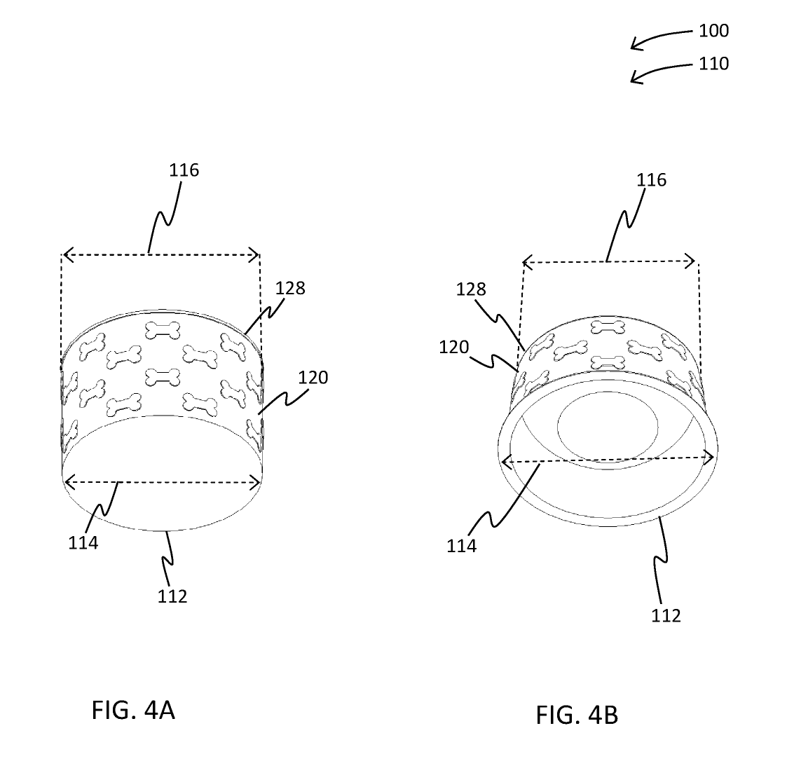

Referring now to FIG. 4A, a bottom perspective view of the pet bowl 100 of FIG. 1, according to an embodiment of the present disclosure. In one embodiment, annular sidewall 120 of container 110 of pet bowl 100 is substantially cylindrical, such that base-diameter 114 of substantially circular base 112 of container 110 is equal (or substantially equal to) to rim-diameter 116 of upper rim 128 of annular sidewall 120 of container 110. In another embodiment, annular sidewall 120 of container 110 is tapered, such that base-diameter 114 of substantially circular base 112 of container 110 is larger than rim-diameter 116 of upper rim 128 of annular sidewall 120 of container 110. In yet another embodiment, annular sidewall 120 of container 110 is tapered, such that base-diameter 114 of substantially circular base 112 of container 110 is smaller than rim-diameter 116 of upper rim 128 of annular sidewall 120 of container 110. Various configurations are envisioned.

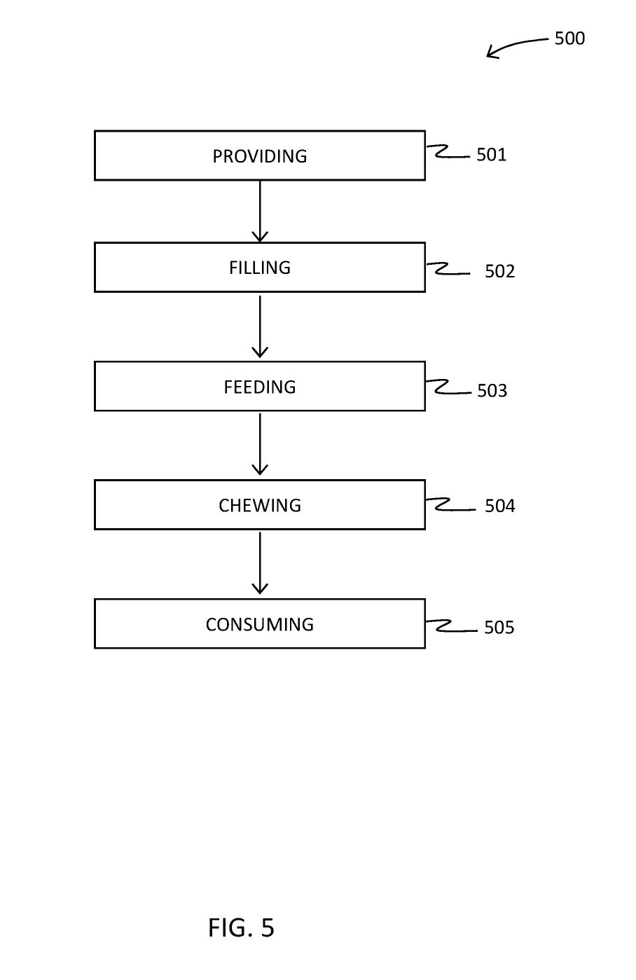

FIG. 5 is a flow diagram illustrating a method for using 500 an edible pet bowl 100, according to an embodiment of the present disclosure. In particular, the method for using 500 an edible pet bowl 100 may include one or more components or features of the pet bowl 100 as described above. As illustrated, the method for using an edible pet bowl 500 may include the steps of: step one 501, providing pet bowl comprising a container constructed of rawhide having a substantially circular base having a base-diameter, and an annular sidewall integrated with the substantially circular base defining an upwardly-facing inner concavity configured to contain fluids and alternatively comestibles, the annular sidewall having an outer wall, an inner wall concentric to the outer wall, and an upper rim terminating the outer wall and the inner wall having a rim-diameter; step two 502, filling the container with a fluid and alternately a comestible; step three 503, feeding from the container; step four 504, chewing the container; and step five 505, consuming the container.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using an edible pet bowl, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet bowl, the apparatus comprising:
a container constructed of rawhide having
a substantially circular base having a base-diameter; and
an annular sidewall integrated with the substantially circular base defining an upwardly-facing inner concavity configured to contain fluids and alternatively comestibles, the annular sidewall having
an outer wall;
an inner wall concentric to the outer wall; and
an upper rim terminating the outer wall and the inner wall having a rim-diameter.

2. The pet bowl of claim 1, wherein the rawhide comprises beef hide.

3. The pet bowl of claim 1, wherein the rawhide comprises pork hide.

4. The pet bowl of claim 1, wherein the rawhide comprises granulated rawhide.

5. The pet bowl of claim 1, wherein the rawhide comprises compressed rawhide.

6. The pet bowl of claim 1, wherein the rawhide includes flavoring additives.

7. The pet bowl of claim 1, wherein the rawhide includes nutritional additives.

8. The pet bowl of claim 1, wherein the rawhide is chewable, such that the rawhide functions as a tooth strengthening mechanism.

9. The pet bowl of claim 1, wherein the rawhide becomes flexible and deformable when saturated with saliva, the container being configured to deform when chewed by an animal.

10. The pet bowl of claim 1, wherein the container further includes a chamfer joining the annular sidewall of the container to the substantially circular base of the container.

11. The pet bowl of claim 1, wherein the annular sidewall of the container is tapered, such that the base-diameter of the substantially circular base of the container is larger than the rim-diameter of the upper rim of the annular sidewall of the container.

12. The pet bowl of claim 1, wherein the annular sidewall of the container is tapered, such that the base-diameter of the substantially circular base of the container is smaller than the rim-diameter of the upper rim of the annular sidewall of the container.

13. The pet bowl of claim 1, wherein the annular sidewall of the container is substantially cylindrical, such that the base-diameter of the substantially circular base of the container is equal to the rim-diameter of the upper rim of the annular sidewall of the container.

14. The pet bowl of claim 1, wherein the upper rim is flared.

15. The pet bowl of claim 1, wherein the container further includes ornamental embellishments molded into the side of the outer wall of the annular sidewall of the container for providing identification and personalization to the pet bowl.

16. The pet bowl of claim 1, wherein the ornamental embellishments resemble bones for providing further identification and personalization to the pet bowl.

17. An edible pet bowl comprising:
a container constructed of rawhide having
a substantially circular base having a base-diameter; and
an annular sidewall integrated with the substantially circular base defining an upwardly-facing inner concavity configured to contain fluids and alternatively comestibles, the annular sidewall having
an outer wall;
an inner wall concentric to the outer wall; and
an upper rim terminating the outer wall and the inner wall having a rim-diameter;
wherein the rawhide is chewable, such that the rawhide functions as a tooth strengthening mechanism;
wherein the rawhide becomes flexible and deformable when saturated with saliva, the container being configured to deform when chewed by an animal;
wherein the container further includes a chamfer joining the annular sidewall of the container to the substantially circular base of the container;
wherein the annular sidewall of the container is substantially cylindrical, such that the base-diameter of the substantially circular base of the container is equal to the rim-diameter of the upper rim of the annular sidewall of the container;
wherein the upper rim is flared;
wherein the container further includes ornamental embellishments molded into the side of the outer wall of the annular sidewall of the container for providing ready identification and personalization to the pet bowl; and
wherein the ornamental embellishments resemble bones for providing further said ready identification and said personalization to the pet bowl.

18. A method of using an edible pet bowl, the method comprising the steps of:
providing pet bowl comprising a container constructed of rawhide having a substantially circular base having a base-diameter, and an annular sidewall integrated with the substantially circular base defining an upwardly-facing inner concavity configured to contain fluids and alternatively comestibles, the annular sidewall having an outer wall, an inner wall concentric to the outer wall, and an upper rim terminating the outer wall and the inner wall having a rim-diameter;
filling the container with a fluid and alternately a comestible;
feeding from the container;
chewing the container; and
consuming the container.
